(19) United States
(12) Patent Application Publication
(10) Pub. No.: US 2026/0195638 A1
(43) Pub. Date: Jul. 9, 2026

(54) ARTIFICIAL INTELLIGENCE MODEL HALLUCINATION DETECTION

(71) Applicant: Lenovo Global Technology (United States) Inc., Morrisville, NC (US)

(72) Inventors: Gary D. Cudak, Raleigh, NC (US); Glenn D. Johnson, Apex, NC (US); Patrick Hartman, Heidelberg (DE); Ajay Dholakia, Cary, NC (US)

(21) Appl. No.: 19/012,028

(22) Filed: Jan. 7, 2025

(51) Int. Cl. G06N 20/00

(52) U.S. Cl. CPC G06N 20/00

(57) ABSTRACT

One embodiment provides a method, the method including: identifying, using an output hallucination detection system, an output that is generated by an artificial intelligence model in response to receiving an input at the artificial intelligence model; detecting, using the output hallucination detection system, a sentiment related to the output and provided by at least one user; determining, based upon the sentiment, an accuracy of the output generated by the artificial intelligence model; and transmitting, responsive to the determining, feedback for the artificial intelligence model, wherein the feedback is generated in view of the sentiment related to the output. Other aspects are claimed and described.

### BACKGROUND

Artificial intelligence models are being utilized for more and more tasks. Some models are being integrated into some applications to analyze information and provide insights into the information so that users can be more efficient or organizations can operate more efficiently. Some models are being integrated into applications to perform specific tasks in a manner that is more consistent than having users perform the task. Some models are even being integrated into applications to analyze user behavior and make recommendations for users. Artificial intelligence models are becoming so ubiquitous that some models are accessible to normal users. Some of these models are generative artificial intelligence models that receive input prompts from users and then generate an output that is responsive to the prompt. These models are able to interact with a user in a manner that is human-like. For example, the model can understand a session context of prompts provided by the user and responses provided by the model that allows the model to build from previous prompts and outputs within a session with the user. Additionally, the model is able to interact with the user utilizing human language instead of machine language.

### BRIEF SUMMARY

In summary, one aspect provides a method, the method including: identifying, using an output hallucination detection system, an output that is generated by an artificial intelligence model in response to receiving an input at the artificial intelligence model; detecting, using the output hallucination detection system, a sentiment related to the output and provided by at least one user; determining, based upon the sentiment, an accuracy of the output generated by the artificial intelligence model; and transmitting, responsive to the determining, feedback for the artificial intelligence model, wherein the feedback is generated in view of the sentiment related to the output.

Another aspect provides a system, the system including: a processor; a memory device that stores instructions that, when executed by the processor, causes the system to: identify, using an output hallucination detection system, an output that is generated by an artificial intelligence model in response to receiving an input at the artificial intelligence model; detect, using the output hallucination detection system, a sentiment related to the output and provided by at least one user; determine, based upon the sentiment, an accuracy of the output generated by the artificial intelligence model; and transmit, responsive to the determining, feedback for the artificial intelligence model, wherein the feedback is generated in view of the sentiment related to the output.

A further aspect provides a product, the product including: a computer-readable storage device that stores executable code that, when executed by a processor, causes the product to: identify, using an output hallucination detection system, an output that is generated by an artificial intelligence model in response to receiving an input at the artificial intelligence model; detect, using the output hallucination detection system, a sentiment related to the output and provided by at least one user; determine, based upon the sentiment, an accuracy of the output generated by the artificial intelligence model; and transmit, responsive to the determining, feedback for the artificial intelligence model, wherein the feedback is generated in view of the sentiment related to the output.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for determining whether an output provided by an artificial intelligence model is accurate based upon sentiment received from at least one user and transmitting feedback for the artificial intelligence model in response to determining whether the output is accurate and in view of the sentiment related to the output.

### DETAILED DESCRIPTION

Depending on its programming, an artificial intelligence model may take training input from one or more sources. A typical source for training input to a language model is the Internet or another large data repository, as such large data stores can provide a vast array of information across numerous subjects as well as a “real-world” corpus of natural language. These characteristics make large data stores particularly useful as sources of training input, such as for a multi-purpose GenAI system destined to receive a variety of prompts related to many different topics. Many AI models do not directly access the Internet in real-time to find answers and once trained will generate responses only based on the patterns and knowledge encoded within their training data, effectively “freezing” their knowledge at a certain point in time.

On the other hand, some AI systems can be designed to query the Internet or specific databases in real-time to fetch information via an integration with external search or data retrieval systems. For example, a context-aware GenAI system can extract salient keywords from a prompts, and then access the Internet or other data repository to find contextual information that can be used to generate an output that is responsive to the prompt. By utilizing this technique, a GenAI model does not have to be trained on a corpus covering all possible information. Rather, the GenAI system is configured or trained to form and execute queries that would allow the model to find relevant information, and then trained to coalesce the information into a single responsive human-understandable output. Thus, by not having to train the model on the information itself, such a model or system may require less training and can be utilized in an application where the model could be prompted with any possible prompt. A system configured in this way may also have increased lifespan as it is less reliant on its internally encoded knowledge of facts, events, and/or the like.

One problem with GenAI models that are trained to generate outputs is that the model may output a response to a prompt even if the model has low or no confidence in the generated output. In other words, the model may be trained to output any response, rather than outputting a response only if it satisfies one or more criteria, such as meeting a certain score or threshold. The use of the Internet as a source of contextual information retrieval may present additional problems. One problem is that information retrieved from the Internet may be incorrectly selected or the information itself may be wrong or inaccurate. Another problem is that when a model obtains the information from the Internet or some other large data repository and pieces it together into an output, the model may inaccurately piece the information together. Each of these problems may result in the model generating inaccurate information. In other words, this is not information that the system gathered that was inaccurate, but rather information that the model made inaccurate in the output. This phenomenon is referred to as a hallucination.

Identifying hallucinations relies on the user who provided the prompt, or possibly other users who may receive the information provided within the output, to identify that the information within the output is inaccurate. This can lead to embarrassment for the user who relied on the output information, since the user may not know that the information contained within the output is inaccurate or the user may not verify the accuracy of the information. Additionally, this inaccurate output may result in the dissemination of the inaccurate information. For example, if the user makes the output provided by the artificial intelligence model accessible by other people, the inaccurate information can be widely viewed. If the information is put on a platform or is from a user who has a high trustworthiness value, people may take the information at face value and may not question whether the information is true or not.

A solution that has been established in many generative artificial intelligence model platforms is the ability for the user to provide input to regenerate a response. The user can tell the platform to regenerate a response and the user can then provide feedback regarding whether the response was better or worse than the previous response. The feedback can then be provided back into the model. While a user may provide this binary feedback when the user finds some information to be inaccurate, the feedback is not specific to the accuracy of the information. Rather, the user could just provide negative feedback if the user is not satisfied with the regenerated response or does not prefer the regenerated response over the initial response. Additionally, even if the feedback is based upon an accuracy of information contained within the response, the feedback does not identify the specific information contained in the response that is the source of the inaccurate information. In other words, a model response could have many different pieces of information contained therein. Not all of the pieces of information may be inaccurate. Thus, even if the feedback is solely to identify inaccurate information, it is unclear which piece of information is inaccurate. Accordingly, the existing solution fails to capture a context associated with the provision of inaccurate information.

Accordingly, the described system and method provides a technique for determining whether an output provided by an artificial intelligence model is accurate based upon sentiment received from at least one user and transmitting feedback for the artificial intelligence model in response to determining whether the output is accurate and in view of the sentiment related to the output. The output hallucination detection system identifies an output provided by an artificial intelligence model that has been provided in response to receiving an input at the model. The output may be provided in response to receiving a prompt at an interface of the model. The output may be in any modality including, but not limited to, text-based output, audible output, video output, image output, haptic output, and/or the like, or a combination thereof.

Once the output has been provided, the output hallucination detection system detects a sentiment related to the output and provided by at least one user. The sentiment may be detected as the user is consuming the output. The sentiment may also be detected in a data repository that may have information related to sentiments of information contained within the output. For example, a news story may be written about information contained within an output and how that information was inaccurate. The system could detect this sentiment within the news story and associated this sentiment with the information of the output. Based upon the sentiment, the system determines whether the output provided by the model is accurate. Determining whether the output is accurate may include determining whether the entire output is accurate or whether pieces of information contained within the output is accurate. Since the sentiment can be associated with singular pieces of information within the output, the system could identify the accuracy of just portions of the output. Upon determining whether the output is accurate, the system may transmit feedback for the model. The feedback is generated in view of the sentiment related to the output.

Therefore, a system provides a technical improvement over traditional methods for identifying inaccurate information or hallucinations in output from an artificial intelligence model. Instead of relying on a post-consumption identification by a consumer that the information contained in the output of the model is incorrect, the described system and method may be able to receive sentiment information from a user while the user is consuming the output, which does not rely on the user to provide binary feedback in the form of positive or negative feedback. Additionally, since the sentiment is detected as the user is reading or otherwise consuming the information, the feedback provided in the form of a sentiment can be associated with a particular piece of information contained within the output. Thus, unlike conventional feedback mechanisms which are attributable to the output at a whole, the described system and method allows for the identification of the piece of information contained within the output that is the most likely cause of the feedback, which allows for more directed feedback to the model, thereby allowing the model to become more accurate over time. Accordingly, the described system and method provides a technique for providing feedback to an artificial intelligence model that is more accurate, more granular, and more effective than conventional techniques.

The illustrated example embodiments will be best understood by reference to the figures. The following description is intended only by way of example, and simply illustrates certain example embodiments.

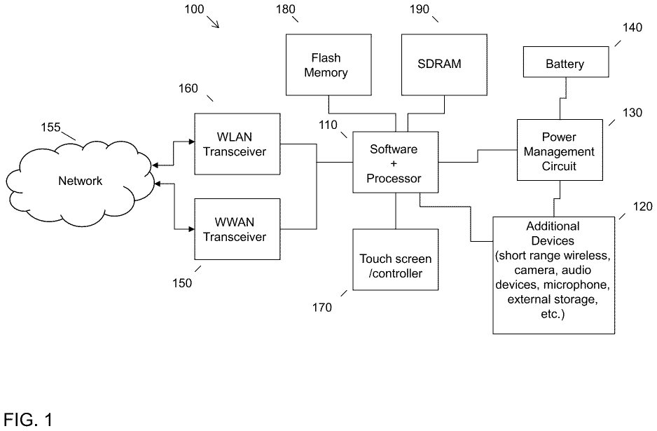

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

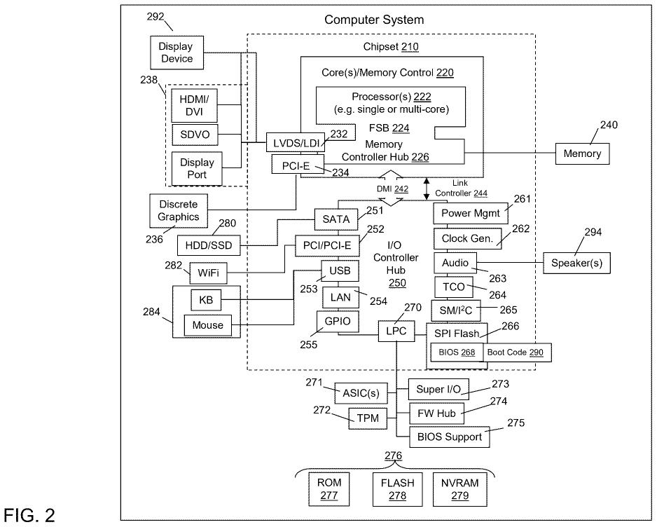

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be devices which are utilized to access or provide input to an artificial intelligence model interface, detect sentiment of a user, house or provide access to the output hallucination detection system, and/or the like. For example, the circuitry outlined in FIG. 1 may be implemented in a tablet or smart phone embodiment, whereas the circuitry outlined in FIG. 2 may be implemented in a personal computer embodiment.

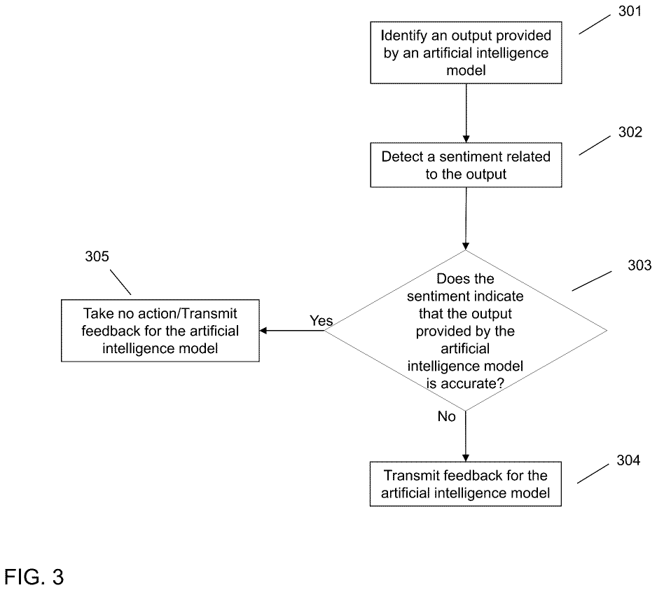

FIG. 3 illustrates an example method for determining whether an output provided by an artificial intelligence model is accurate based upon sentiment received from at least one user and transmitting feedback for the artificial intelligence model in response to determining whether the output is accurate and in view of the sentiment related to the output. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to determine whether an output provided by an artificial intelligence model is accurate and transmit feedback for the artificial intelligence model. Additionally, the output hallucination detection system includes modules and features that are unique to the described system.

The output hallucination detection system may be activated in order to determine an accuracy of information contained within output of the artificial intelligence model using sentiment detected from a user. Thus, the system may be activated upon activation of an artificial intelligence model in order to detect a sentiment of a user as the user is consuming the output from the model. Additionally, the system is able to access and detect sentiment related to outputs of a model in data repositories. Accordingly, the output hallucination detection system may be activated to mine information from secondary sources or data repositories in order to identify sentiments related to output of the model. Once the sentiment has been detected, the output hallucination detection system can determine whether output provided by the model is accurate. Once this determination has been made, the system can transmit feedback, for the model, that is generated in view of the sentiment related to the output.

Activation of the output hallucination detection system may be a manual activation of the output hallucination detection system and/or an automatic activation of the output hallucination detection system. Manual activation of the system may include a user opening an application associated with the output hallucination detection system, the user accessing the computing system associated with the output hallucination detection system, and/or the user otherwise providing input to the output hallucination detection system. The automatic activation of the output hallucination detection system may be based upon the detection of a trigger event indicating that the system should be activated. Example trigger events include the user accessing an artificial intelligence model or model interface, a user being provided with output from a model, information being added to a data repository, a user accessing an application that interfaces with the output hallucination detection system, activation of software or an application utilizing the output hallucination detection system, and/or the like.

The output hallucination detection system may be made of multiple systems or modules that communicate together to make up the output hallucination detection system or may be a single system. The output hallucination detection system may be a standalone system, may be accessible through other computing devices, and/or a combination thereof. For example, the output hallucination detection system may be a standalone system that can be accessed by a user and/or may be or provide an application that is accessible by a user on another computing device. The output hallucination detection system may be accessible using any type of computing device, for example, personal computer, laptop computer, smartphone, tablet, smartwatch, head-mounted display, smart television or other smart appliance, augmented reality device, virtual reality device, and/or the like. Thus, the output hallucination detection system may be accessible locally using a computing device where the output hallucination detection system is installed and/or may be accessible remotely through another computing device. For example, the output hallucination detection system may be accessed by a user using a device that communicates with the output hallucination detection system to provide output from an artificial intelligence model, detect sentiment related to an output provided by a model, determine whether an output provided by the model is accurate, transmit feedback for a model, and/or the like. However, the output hallucination detection system may be located and operate on a different information handling device to perform the described steps.

The determination of whether output provided by a model is accurate using sentiment detected from a user can be provided as a service to other entities or companies. In other words, the output hallucination detection system could be stored on a server or network of a company and the system could determine an accuracy of the output and transmit feedback for the model, with the other companies or entities paying for the determination of the accuracy of the output or feedback or use of the output hallucination detection system.

The output hallucination detection system may have an associated graphical user interface. The graphical user interface may be provided on a display or monitor, which may or may not be associated with the output hallucination detection system. In other words, the output hallucination detection system may have a dedicated display or monitor or may be accessible using any display or monitor. In either case, the output hallucination detection system may provide instructions to generate and display the graphical user interface on the display device being used to access the output hallucination detection system. The graphical user interface may also be updated and managed based upon instructions provided by the output hallucination detection system. In other words, the output hallucination detection system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the output hallucination detection system. For example, the output hallucination detection system may utilize a user profile, historical information, and/or the like, to detect a sentiment related to an output, determine whether the output is accurate, transmit feedback for the artificial intelligence model, and/or the like. The graphical user interface may allow for creation of or access to these profiles, historical information, and/or the like, by allowing a user to input information regarding user preferences, user expertise information, and/or the like. As will be discussed in more detail, the use of user provided information is not the only way that the profile and/or historical information can be created. The output hallucination detection system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, display information related to a detected sentiment, display information related to feedback transmitted to an artificial intelligence model, and/or the like. It should be noted that the information to be used by the output hallucination detection system and information provided by the output hallucination detection system can be different for different applications, different computing systems, different users, and/or the like. Thus, the information corresponding to input or output of the output hallucination detection system are not always the same. However, the output hallucination detection system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The output hallucination detection system may utilize one or more artificial intelligence models in detecting a sentiment and determining whether output provided by an artificial intelligence model is accurate. Artificial intelligence models could be designed to perform the detection of the sentiment, determination of an accuracy of the output of an artificial intelligence model, transmission of the feedback, or any other steps within the described system. Artificial intelligence models may also be used for steps within a step. For example, a model could be utilized to capture input that can be analyzed for a sentiment, analyze the sentiment to determine whether an output is accurate, analyze a user profile in view of a detected sentiment to determine an accuracy of an output, generate feedback to be transmitted for an artificial intelligence model, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the output hallucination detection system or may be a model that is created from scratch. Since the output hallucination detection system is used in conjunction with detecting sentiment related to an output and determining whether the output is accurate based upon the sentiment, some models that may be utilized by the system are image analysis models, text analysis models, analysis models, sentiment identification models, similarity identification models, language models, large language models, entity identification models, input analysis models, filtering models, classification models, and/or the like. The model may be trained using one or more training datasets. Additionally, as the model is deployed, it may receive feedback to become more accurate over time. Alternatively, or additionally, the model may utilize inputs provided to the model to continually learn, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The output hallucination detection system may include different components for carrying out different functions of the system, including different steps to be performed. These components may be hardware components or software components. Some hardware devices or components that may be utilized by the output hallucination detection system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the output hallucination detection system. For example, the output hallucination detection system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the output hallucination detection system, and/or the like.

One software component may include a data storage location or data repository that stores information related to sentiment analyses, secondary sources of information from which the output hallucination detection system can pull and analyze sentiment, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by output type or topic, grouped by expertise level, grouped by model type, and/or the like.

Another software component includes a user profile that stores information related to a user and user preferences. The output hallucination detection system may utilize expertise information regarding a user in determining whether an output provided by an artificial intelligence model is accurate. The expertise information or information from which expertise information can be inferred may be stored in a user profile. To identify expertise information, the user may manually provide information into the user profile that is related to the expertise of the user. For example, the user may complete a questionnaire that asks the user to identify a level of expertise related to particular fields, topics, content, and/or the like. As another example, the user can identify, within the user profile, fields of expertise.

The user can also provide information from which expertise information can be inferred. For example, the user could upload a resume, curriculum vitae, a listing of publications, a link to websites discussing the qualifications of the user, and/or the like. Thus, any information which could also the system to determine an expertise level of the user with respect to a particular field, topic, content, and/or the like, may be provided within the profile, could be inferred from information identified within the profile, and/or the like. In inferring expertise information, the system may utilize one or more techniques that allows for the inference of information including, but not limited to, rules engines, artificial intelligence models, correlation techniques, and/or the like. These techniques may take the identified information as input, analyze that input based upon the technique programming, and provide an output related to the expertise level of the user. This information may then be placed within the user profile for later access.

The user profile may also contain other information, for example, information related to preferences of the user. For example, the user profile may include information related to when the output hallucination detection system can detect a sentiment of the user, when feedback should be transmitted for an artificial intelligence model, whether the user wants user identifying information transmitted within the feedback, and/or the like. Other profiles may include an artificial intelligence model profile. This profile may identify when feedback should be transmitted for the model (e.g., when the feedback confidence level has reached a certain threshold, when a certain number of sentiments have been identified with respect to particular content, when the feedback corresponds to a user having a particular expertise level, etc.). The model profile may also identify how feedback is transmitted for the model. The feedback may be transmitted directly to the model, may be transmitted to a system associated with the model, may be transmitted to a data repository to be verified at a later time, and/or the like.

Any of the mentioned profiles, or other profiles, may include additional information that may be useful for the output hallucination detection system and may be entered by a user, may be default values, may be learned by the system over time, and/or the like. Thus, profiles can be populated with information manually by a user, entities or companies, and/or the like, or can be populated over time as the system learns more about the user, models, entities or companies, and/or the like. For example, a user may manually provide input to a user profile and the system can learn preferences about the user over time and populate the user profile with this learned information. Learned information may be information learned based upon direct inputs, for example, a user may be presented with a pop-up window in response to a trigger and provide input to the pop-up window. This input can be then populated into the user profile.

Learned information may also be information learned based upon indirect inputs, for example, a user may provide inputs (e.g., audible inputs, visual inputs, gesture inputs, etc.) that indicate that the user would like to provide a sentiment, indicate that the user is interested in transmitting feedback for the model, and/or the like. The system can then aggregate this information to learn preferences of the user. Similarly, the system can learn information for model profiles or other profiles. With respect to the described output hallucination detection system, the learned information may include historical information, correlations between sentiments and an accuracy of outputs of an artificial intelligence model, and/or the like.

At 301, the output hallucination detection system identifies an output provided by an artificial intelligence model. The output provided by the artificial intelligence model is provided in response to receiving an input at the artificial intelligence model. For ease of readability, this artificial intelligence model will be referred to as the target artificial intelligence model or AI model. This is to distinguish this target AI model from any AI models that may be utilized by the output hallucination detection system in performing one or more of the steps as described herein. Additionally, for ease of readability, the discussion will refer to a single target AI model. However, the output hallucination detection system can be utilized with many target AI models, many instances of a single type of target AI model, many instances of multiple types of target AI models, target AI models of a single company or entity, and/or the like.

For illustrative purposes, the target AI model example that will be used here throughout will be a generative AI model or GenAI model. However, this is intended to be non-limiting, as the described system and method can be utilized for any type of target AI model that provides output responsive to inputs received at the target AI model, particularly those target AI models that provide outputs to users or provide outputs that are consumable by a user. For example, the target AI model could provide an output directly to a user or could provide an output that is incorporated into a format that is consumable by a user. Additionally, for illustrative purposes, the output will be described as being provided on a display device in a text-based form or modality. However, this is intended to be non-limiting, as the output can be provided in any different format or modality, for example, a text-based modality, an audio-based modality, an image-based modality, a haptic-based modality, and/or the like, or a combination thereof.

While the output may be provided by the target AI model in response to an input received at the target AI model, the identification of the output may be at a later time. In other words, the output hallucination detection system may identify that an output has been provided by a target AI model at some time after the output was actually provided by the target AI model. Thus, the output hallucination detection system may identify the output in real-time as the output is being provided by the target AI model or may identify the output at some time subsequent to the provision of the output by the target AI model. For example, the output hallucination detection system may monitor outputs provided by a target AI model as the target AI model is providing the outputs, the output hallucination detection system may monitor a data repository that contains outputs provided by a target AI model, the output hallucination detection system may monitor a data repository that includes information that may contain portions of outputs provided by the target AI model, and/or the like, or a combination thereof.

In identifying the output provided by the target AI model, the output hallucination detection system may identify other information related to the output. Not only will the output hallucination detection system identify which AI model or AI model type corresponds to the provided output, but may also identify a topic of the output. The topic may identify the subject of the output. The output could contain multiple topics. Thus, the output hallucination detection system can identify topics for different portions of the output. The output hallucination detection system may keep track of which portions of the output correspond to the different topics. In identifying the topic, the output hallucination detection system may utilize output analysis techniques. The output analysis techniques may include techniques that are based upon the type of the output, for example, text analysis techniques, audio analysis techniques, image analysis techniques, and/or the like. The output analysis techniques may also include, but are not limited to, analysis techniques that could be utilized across different output types or modalities, for example, entity identification techniques, semantic analysis techniques, syntactic analysis techniques, information identification analysis techniques, parts of speech analysis techniques, content analysis techniques, and/or the like. The output analysis techniques may include different analysis mechanisms, for example, artificial intelligence models, rules engines, comparison analysis, and/or the like.

The granularity of the topic identification may be based upon default settings, target AI model system settings, user provided settings, and/or the like. The granularity of the topic identification refers to how broadly the topic is defined. For example, the topic could be defined broadly as field or could be defined narrowly as a specific focus of a field. The granularity of the identified topic may also be based upon how specialized the field is or how detailed the information within the output is. For example, a field having many different subspecialities or being highly specialized may have are more granular topic identification as compared to a less specialized field. As another example, if the information within the output is provided in broad or general terms, the topic identification may be less granular than if the information within the output is provided in specific terms. Thus, more details within the output could result in a more granular topic identification.

At 302, the output hallucination detection system may detect a sentiment related to the output and provided by at least one user. In other words, the output hallucination detection system may detect a sentiment that has been provided by at least one user. The sentiment that is detected is also identified as being related to the output that was identified at 301. The output hallucination detection system can detect a sentiment provided by at least one user at the same time, or nearly the same time, that the user is consuming the output. In other words, the output may be provided to a user and the output hallucination detection system may monitor the user as the user is consuming the output. Thus, the output hallucination detection system may detect a sentiment or sentiment provided by the user in real-time, or near real-time, as compared to a time of receipt of the output by the user or when the output is being provided by the target AI model. For example, using the text-based output modality, as the user reads the output, the output hallucination detection system monitors the user to detect a sentiment of the user as the user is reading the output. To determine a portion that the user is reading, or otherwise consuming, at a time when the sentiment is detected, the output hallucination detection system may keep track of the portion of the output that is being consumed at any time.

In the example of the user reading or visually consuming the output, the output hallucination detection system could utilize gaze tracking to determine a location where the user is viewing. The system can then correlate this location with the content that is included on the display device at that location. As another example, if the user is audibly consuming the output, the output hallucination detection system can mark the audio or keep track of a time stamp corresponding to a location within the audio that is associated with a detected sentiment. The system can then correlate this location with the content that is included within the audio at that location. Similar techniques can be utilized to correlate topics of the output with the detection of a sentiment.

Sentiment may identify how a user feels about a particular piece of information as the user is consuming the information. The output hallucination detection system may detect a particular type of sentiment (e.g., confused, shocked, happy, agreement, angry, disagreement, disbelief, belief, etc.) or may detect a connotation of the sentiment (e.g., negative, positive, neutral, etc.). Since the output hallucination detection system is attempting to determine whether output provided by the target AI model is accurate, the output hallucination detection system may only detect when particular types of sentiment have been provided by a user. These types of sentiment may include sentiments that are associated with negative feelings or other feelings that may indicate that information may be inaccurate. In other words, the output hallucination detection system may identify the sentiment is a sentiment indicating that the output is inaccurate.

Alternatively, or additionally, the output hallucination detection system may detect when any type of sentiment is detected. The output hallucination detection system may detect a change in sentiment. For example, while the user is consuming the output, the sentiment of the user may change. The output hallucination detection system may only detect the changes in sentiment and may then detect a type of change, for example, from negative to positive, from neutral to negative, from positive to negative, and/or the like. Detecting a change in sentiment may assist in determining which exact portion of the output corresponds to a particular detected sentiment. Whether sentiment is detected at all time, only upon detection of a change in sentiment, only upon detection of a particular connotation of sentiment, and/or the like, may be based upon default settings, user identified settings, learned by the output hallucination detection system over time, and/or the like.

Detecting the sentiment may include monitoring the user and detecting changes in the user that would reflect a particular sentiment. The sentiment may include a reaction such as, but not limited to, a facial expression, an audible output, a gesture output, a textual output, and/or the like. As an example, in the case that the output hallucination detection system is monitoring facial expressions of the user, the output hallucination detection system can compare the detected facial expressions to facial expressions having known or labeled sentiments. As another example, in the case that the output hallucination detection system is monitoring text input provided by the user, the output hallucination detection system can parse the text and detect a sentiment of the text. As another, non-limiting example, in the case that the output hallucination detection system is monitoring audio input provided by the user, the output hallucination detection system can detect a tonality of an input provided by the user to detect a change in sentiment. One technique that may be particularly useful in detecting the sentiment is the use of an artificial intelligence model that is trained for sentiment analysis. Other techniques include, but are not limited to, rules engines, comparison techniques, and/or the like. Thus, the output hallucination detection system can utilize any type of sentiment analysis technique to detect the sentiment of the user.

In addition to detecting sentiment, the output hallucination detection system may also determine if the user is providing a sentiment in response to the output of provided by the target AI model or to something else. In other words, to accurately identify whether the output is accurate, the output hallucination detection system may need to ensure that a detected sentiment is actually in response to information contained within the output and not to something else. Accordingly, the output hallucination detection system may utilize focus detection techniques, gaze tracking techniques, environment analysis techniques, and/or the like, to determine what the user is focusing on when the sentiment is detected. For example, if the output is a text-based output and the system determines that the user has provided a frown but is not looking at the text-based output, the output hallucination detection system may determine that the negative sentiment associated with a frown is not in response to the output provided by the target AI model.

As a converse example, if the output is an audio-based output and the output hallucination detection system determines that the user is listening to the output through headphones and appears to be intently listening, when the user has a confused look, the output hallucination detection system may determine that the confusion is in response to the output provided by the target AI system. Accordingly, the output hallucination detection system may identify a focus of the user when a sentiment is detected, may determine if there are distractions within the environment when a sentiment is detected, or may perform other analyses when a sentiment is detected to determine if the sentiment is in response to the output.

The output hallucination detection system may also be able to detect multiple sentiments for the same portion of the output and compare the sentiments. For example, a user may re-consume a particular piece of the output. During each of these consumptions, the output hallucination detection system may determine the sentiment of the user and determine if the sentiment matches or has a similar connotation (e.g., negative sentiment, positive sentiment, neutral sentiment, etc.) between the different determinations. This allows the output hallucination detection system to increase or decrease a confidence level with respect to determining whether a detected sentiment is in response to consumption of an output or portion of an output.

The output hallucination detection system can also detect a sentiment that is responsive to the output but is not provided at the same time that the output was provided by the target AI model. In other words, the output hallucination detection system can detect a sentiment that is related to an output, but that is not detected when the output is being provided by the target AI model or is not detected during an AI session where the output has been provided. To detect this sentiment, the output hallucination detection system may access the data repository. Within this data repository may be information that is related to the output that was provided or identified. Thus, the output hallucination detection system may identify information within the data repository that is related to the output. The output hallucination detection system may then identify a sentiment included in the information that is related to the output. Thus, the output hallucination detection system can utilize the information in the data repository to identify a sentiment related to previously provided output and then use this as the detected sentiment.

For example, the data repository may include a news article that identifies output that was provided by a target AI model. Sentiment information may also be included in the news article that provides an indication of whether the output was accurate. Regardless of whether the sentiment is detected in the same AI session as the output was provided or from a secondary source that includes previously provided outputs of a target AI model, the output hallucination detection system can utilize any of the previously discussed techniques for detecting the sentiment, identifying the sentiment, and determining the information within the output that corresponds to the detected sentiment. The output hallucination detection system may also utilize a data repository to corroborate a sentiment that was detected in the same AI session as the output was provided. In other words, the system could detect a sentiment and then access a data repository to increase or decrease a confidence level associated with the sentiment.

In addition to detecting the sentiment, the output hallucination detection system can determine an expertise of the user who has provided the sentiment. In determining the expertise, the output hallucination detection system may access the user profile that indicates an expertise level of the user. The system may also identify the expertise in other ways, for example, accessing secondary sources (e.g., organization charts, Internet sources, sources that may be internal to a company or entity of the user, published papers, social media profiles, etc.), receiving an indication from other users who might know the user, and/or the like. The system may correlate the expertise level of the user with the topic that was identified for the output or the portion of the output where the sentiment was detected. In other words, the output hallucination detection system may identify the expertise level of the user that corresponds to the target portion of information.

In addition to detecting a sentiment from one user, the output hallucination detection system may detect sentiment from more than one user, where each user has provided a sentiment corresponding to the output or a portion of the output. In one example scenario, a group of users may be within the same room or may be receiving the output at the same time. The output hallucination detection system can identify the sentiment of each of the users as the output is being consumed. The output hallucination detection system could then aggregate the sentiment provided by all of the users. In a similar example scenario, a group of users may be receiving output that includes the same or similar information. However, instead of being in the same room or receiving the output at the same time, the users may be located in different locations or receiving the output at different times. In this scenario, the output hallucination detection system can keep track of the information in the output and then the sentiment that was received from each of the users with respect to the information in the output. The system can then aggregate the sentiment from all the users into a single sentiment for the output.

When aggregating the sentiment, the output hallucination detection system may weight the detected sentiment based upon the user providing the sentiment. The weighting may be based upon the expertise of the user, may be based upon whether the user has a user profile, may be based upon whether the user has been identified as an expert, and/or the like, or a combination thereof. Thus, when aggregating the sentiment, sentiment from some users may have a higher weight within the aggregated sentiment as compared to sentiment received from other users. Aggregating the sentiment may also include utilizing the detected sentiments to create a single sentiment, but that is not a collection of the detected sentiments. For example, the output hallucination detection system could identify that a majority of the detected sentiment is the same or has a similar connotation, could identify that three out of five users have provided a similar sentiment, could identify that at least a particular percentage of the users have provided a similar sentiment, and/or the like. The aggregation could then be that the sentiment is detected as corresponding to whatever sentiment type has reached the threshold. Thus, the end result is a single sentiment, but the single sentiment is identified from the sentiments of the multiple users. Alternatively, regardless of whether the users receive the output at the same time or not, the system could keep the detected sentiment separate instead of aggregating it.

At 303, the output hallucination detection system may determine if the output provided by the target artificial intelligence model is accurate as indicated by the sentiment. It should be noted that this does not have to be a binary interpretation, meaning the system may not determine if the information is accurate or inaccurate. Rather, the system may determine an accuracy of the output. This determination is made based upon the sentiment that was detected at 302. Thus, the output hallucination detection system correlates the sentiment with an accuracy of information. Accordingly, the output hallucination detection system identifies whether the sentiment reflects a belief of the user with respect to the information. For example, a negative sentiment may indicate that the user does not believe the information, whereas a positive sentiment may indicate that the user does believe the information. Different sentiment may have more of an indicator of accuracy even if the sentiment may have the same sentiment type (e.g., positive, negative, neutral, etc.). For example, a shocked sentiment may be a stronger indicator of inaccuracy as compared to a confused sentiment. The correlation between sentiment and accuracy may be identified using a rules engine, based upon a comparison analysis, using an artificial intelligence model, may be identified in a sentiment profile, may be identified by an entity or user, and/or the like.

Determining if the output is accurate may be based upon the aggregated sentiment that was detected from multiple users with respect to the output. For example, the aggregated sentiment may be the sentiment that was received from multiple users and that corresponded to the same topic of the output. Thus, the output does not have to be identical between multiple users to aggregate the sentiment. Rather, the output hallucination detection system can keep track of outputs that are based upon the topic of the output and group or aggregate the sentiment that is detected in response to the topic of the output, even if the exact output is not the same between the users. Additionally, determining an accuracy of the output may be based upon the weighting of the sentiment that was based upon the expertise of the user providing the sentiment. Thus, sentiment provided by users who are experts in a field may have a higher weighting regarding an accuracy determination as compared to users who are not considered experts.

In addition to determining if the output is accurate, the output hallucination detection system may assign a confidence value or level to the determination. In other words, the output hallucination detection system may identify how confident the system is with respect to the determination of whether the output is accurate. A confidence level that is below a particular threshold may result in the output hallucination detection system attempting to confirm the accuracy utilizing another source or by providing the output to one or more identified experts in the field related to the output. Thus, the output hallucination detection system could attempt to increase a confidence level regarding an accuracy of the output. Alternatively, if the confidence level is above a predetermined threshold, the output hallucination detection system may simply identify the accuracy of the output without taking any further steps. However, the system could also try to confirm the accuracy of the output. The steps that the output hallucination detection system takes in response to a particular confidence level can be default steps, set by a system or entity corresponding to the target AI model, set by a user of the output hallucination detection system, and/or the like. The confidence level could also be stored with the accuracy determination and utilized in generating the feedback.

If, at 303, the output hallucination detection system determines that the output provided by the target artificial intelligence model is accurate (yes branch of 303), the output hallucination detection system may take no action at 305. Alternatively, the output hallucination detection system may transmit feedback for the artificial intelligence model. In this case, the feedback would be generated in view of the sentiment and would indicate that the output was accurate. Thus, the sentiment can be utilized to reinforce the information for the target AI model. This may allow the target AI model to increase a confidence level associated with a particular output or information contained within an output.

If, on the other hand, at 303, the output hallucination detection system determines that the output provided by the target artificial intelligence model is not accurate (no branch of 303), the output hallucination detection system may transmit feedback for the target artificial intelligence model at 304. In this case, the feedback would be generated in view of the sentiment and would indicate that the output is inaccurate. Since the sentiment can be aggregated and weighted, the feedback may reflect the aggregations and weights. In other words, the feedback may be generated by weighting the sentiment from multiple users and aggregating the sentiment that has been weighted into the feedback. Accordingly, instead of just feedback indicated that an output is accurate or inaccurate, the output hallucination detection system may also provide the sentiment, weighted sentiment, and/or the like, within the feedback. This may allow the target AI model system to determine how the feedback should be treated.

Transmitting the feedback for the target AI model may include transmitting the feedback directly to the target AI model. Alternatively, or additionally, transmitting the feedback may include transmitting the feedback to a system or entity that corresponds to the target AI model. In other words, instead of the target AI model receiving the feedback directly, another component may receive the feedback and make a determination of how the feedback will be treated. Thus, while the feedback is for the target AI model, it may not be transmitted directly to the target AI model. This may allow the entity or target AI model system to validate or verify the feedback before the target AI model is retrained or utilizes the feedback for responses. Whether the feedback is transmitted directly to the target AI model, a data repository for the target AI model, a system or entity corresponding to the target AI model, and/or the like, may be based upon programming or policies of the target AI model entity or system, programming of the output hallucination detection system, default settings, user settings, and/or the like. Additionally, different feedback can be treated differently. For example, feedback having a certain confidence level may be transmitted directly to the target AI model, whereas feedback having a confidence level under a particular threshold may be transmitted to a system or quarantine component of the target AI model for validation.

How the feedback is utilized by the target AI model may be based upon the policies of the target AI model. The target AI model may be programmed with policies that identify how information or feedback should be treated. Such policies may also identify how the target AI model treats similar output. For example, the policies could indicate that the feedback will be used to prevent certain output from being provided, indicate that the output will be provided with a disclaimer related to an accuracy of the output, indicate that the feedback should be ignored unless a certain confidence level of accuracy is met, and/or the like. Thus, the feedback is transmitted for the target AI model and the target AI model and corresponding system determine what to do with respect to the feedback and how/if subsequent outputs will be provided.

As an overall non-limiting example of the described system, an output hallucination detection system may be programmed to work with a generative artificial intelligence (GenAI) model. Specifically, the output hallucination detection system has been set up to monitor outputs from a GenAI model and determine whether the outputs from the GenAI model are accurate. As the GenAI model provides outputs responsive to inputs received at the GenAI model, the output hallucination detection system monitors a user reading the output from the GenAI model. The user has a user profile indicating that the user is considered a subject matter expert in a field of semiconductor fabrication. As the user is reading the output, which has some information related to semiconductor fabrication, the output hallucination detection system is capturing images of the user.

In this example, the output related to the semiconductor fabrication is inaccurate. When the user reads the information related to the semiconductor fabrication, the user gets a confused look, which is captured by the output hallucination detection system. Since the system is able to determine the information that the user was reading at the time of the confused look, the system is able to identify that the detected sentiment, confusion, is related to the semiconductor fabrication information. Since the user is considered a subject matter expert in the field of semiconductor fabrication, the system is able to determine that the information contained within the output related to the semiconductor fabrication is incorrect. The output hallucination detection system transmits the feedback (i.e., that the semiconductor fabrication information is inaccurate) for the GenAI model. In this example, transmitting the feedback includes transmitting the feedback to a system that supports the GenAI model. That system then utilizes the feedback as deemed appropriate by the system with respect to the GenAI model.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using an output hallucination detection system, an output that is generated by an artificial intelligence model in response to receiving an input at the artificial intelligence model;
detecting, using the output hallucination detection system, a sentiment related to the output and provided by at least one user;
determining, based upon the sentiment, an accuracy of the output generated by the artificial intelligence model; and
transmitting, responsive to the determining, feedback for the artificial intelligence model, wherein the feedback is generated in view of the sentiment related to the output.

2. The method of claim 1, wherein the identifying an output comprises identifying a topic of the output.

3. The method of claim 2, wherein the determining is based upon aggregating the sentiment detected from a plurality of users based upon the topic of the output.

4. The method of claim 1, wherein the detecting a sentiment comprises accessing a data repository, identifying information within the data repository related to the output, and identifying a sentiment included in the information.

5. The method of claim 1, wherein the detecting a sentiment comprises detecting the sentiment provided by the at least one user at a time of receipt of the output by the at least one user.

6. The method of claim 5, wherein the determining comprises identifying the sentiment comprises a sentiment indicating the output is inaccurate.

7. The method of claim 1, wherein the detecting a sentiment further comprises determining an expertise of the at least one user.

8. The method of claim 7, wherein the determining comprises weighting the sentiment in view of the expertise of the at least one user providing the sentiment.

9. The method of claim 1, wherein the detecting comprises detecting sentiment from a plurality of users and wherein the determining comprises aggregating the sentiment provided by the plurality of users.

10. The method of claim 1, wherein the detecting comprises detecting sentiment from a plurality of users and wherein the determining comprises weighting the sentiment detected from each of the plurality of users and aggregating the sentiment that has been weighted.

11. A system, the system comprising:
a processor;
a memory device that stores instructions that, when executed by the processor, causes the system to:
identify, using an output hallucination detection system, an output that is generated by an artificial intelligence model in response to receiving an input at the artificial intelligence model;
detect, using the output hallucination detection system, a sentiment related to the output and provided by at least one user;
determine, based upon the sentiment, an accuracy of the output generated by the artificial intelligence model; and
transmit, responsive to the determining, feedback for the artificial intelligence model, wherein the feedback is generated in view of the sentiment related to the output.

12. The system of claim 11, wherein the identifying an output comprises identifying a topic of the output.

13. The system of claim 12, wherein the determining is based upon aggregating the sentiment detected from a plurality of users based upon the topic of the output.

14. The system of claim 11, wherein the detecting a sentiment comprises accessing a data repository, identifying information within the data repository related to the output, and identifying a sentiment included in the information.

15. The system of claim 11, wherein the detecting a sentiment comprises detecting the sentiment provided by the at least one user at a time of receipt of the output by the at least one user.

16. The system of claim 15, wherein the determining comprises identifying the sentiment comprises a sentiment indicating the output is inaccurate.

17. The system of claim 11, wherein the detecting a sentiment further comprises determining an expertise of the at least one user and wherein the determining comprises weighting the sentiment in view of the expertise of the at least one user providing the sentiment.

18. The system of claim 11, wherein the detecting comprises detecting sentiment from a plurality of users and wherein the determining comprises aggregating the sentiment provided by the plurality of users.

19. The system of claim 11, wherein the detecting comprises detecting sentiment from a plurality of users and wherein the determining comprises weighting the sentiment detected from each of the plurality of users and aggregating the sentiment that has been weighted.

20. A product, the product comprising:
a computer-readable storage device that stores executable code that, when executed by a processor, causes the product to:
identify, using an output hallucination detection system, an output that is generated by an artificial intelligence model in response to receiving an input at the artificial intelligence model;
detect, using the output hallucination detection system, a sentiment related to the output and provided by at least one user;
determine, based upon the sentiment, an accuracy of the output generated by the artificial intelligence model; and
transmit, responsive to the determining, feedback for the artificial intelligence model, wherein the feedback is generated in view of the sentiment related to the output.
